(19) United States
(12) Patent Application Publication
(10) Pub. No.: US 2016/0070876 A1
(43) Pub. Date: Mar. 10, 2016

(54) METHODS AND SYSTEMS FOR INFORMATICS DATA VISUALIZATION AND ALERTS

(71) Applicant: General Electric Company, Schenectady, NY (US)

(72) Inventors: Adrian F. Warner, Wauwatosa, WI (US); Claudio Patricio Mejia, Wauwatosa, WI (US); Daniel Richard Schneidewend, Wauwatosa, WI (US); Sahika Genc, Niskayuna, NY (US); Nicholas Paul Nekich, Wauwatosa, WI (US); Hans-Peter Stoll, Wauwatosa, WI (US)

(21) Appl. No.: 14/478,016

(22) Filed: Sep. 5, 2014

(51) Int. Cl. G06F 19/00

(52) U.S. Cl. CPC G06F 19/3431; G06F 19/322

(57) ABSTRACT

A method and system for generating a patient condition index. The method and system receive and analyze physiological parameters (PP) of a patient to generate a PP related risk indicator. The method and system access and analyze data from a patient history (PH) database to generate PH related risk indicator. The method and system acquire parameter risk definitions and generate a synthetic informatics signal combining the PP related risk indicator and the PH related risk indicator according to the parameter risk definitions, and display the synthetic informatics signal on a display.

### BACKGROUND OF THE INVENTION

The subject matter disclosed herein relates generally to systems and methods for visualizing synthetic informatics signals corresponding to a risk or condition of a patient.

Discrete or single parametric based alarm systems are conventionally used to measure medical conditions of a patient based on a single physiological measurement, such as, blood pressure, heart rate, or the like. Conventionally, the single parametric based alarm system is configured with predetermined thresholds corresponding to a physiological measurement, for example, as shown in U.S. Publication No. 2012/0319848, title “Method, arrangement and computer program product for managing alarms in patient monitoring,” U.S. Publication No. 2013/0261415, titled “System and methods for physiological monitoring,” and U.S. Publication No. 2014/0073860, titled “SENSOR, MONITORING SYSTEM AND METHOD FOR PHYSIOLOGICAL MEASUREMENT,” all of which are hereby expressly incorporated herein by reference in its entirety.

Once the physiological measurement falls below and/or above the set threshold the single parametric based alarm system transmits an alert or alarm for a clinician. The physiological measurement information measured by the single parametric based alarm system has been grouped into menus and other workflow methods attempting to deliver appropriate information sources directed by a clinician. However, these single parametric alarm systems must be used in conjunction with clinical teams, intervention devices and imaging systems to determine an overall condition of the patient beyond physiological measurements. Indeed, during specific medical procedures the patient may be purposely placed in situations that is an alarm event by the single parametric based alarm system resulting in false alarms driving alarm fatigue and consequential loss of relevance. There is a need to solve the limitations of single parametric based alarm system incorporating derived situational awareness of the condition of the patient.

### BRIEF DESCRIPTION OF THE INVENTION

Certain embodiments of the present disclosure provide, a method for generating a patient condition index. The method includes receiving physiological parameters (PP) of a patient, and analyzing data from the PP to generate a PP related risk indicator. The method includes accessing a patient history (PH) database, and analyzing data from the PH database to generate PH related risk indicator. The method includes acquiring parameter risk definitions. The parameter risk definition defines a set of rules for combining the PP and PH related risk indicators to form a synthetic informatics signal. The method includes generating a synthetic informatics signal by combining the PP and PH related risk indicators according to the parameter risk definitions, and displaying the synthetic informatics signal on a display.

Certain embodiments of the present disclosure provide, a system for generating a patient condition index. The system includes one or more physiological sensors configured to acquire physiological parameters from a patient, a memory device configured to store a patient history (PH) database; and a display configured to display a synthetic informatics signal; and a controller. The controller configured to receive physiological parameters (PP) from the physiological sensors, analyze data from the PP to generate a PP related risk indicator, analyze data from the PH database to generate PH related risk indicator, and acquire parameter risk definitions. The parameter risk definition defines a set of rules for combining the PP and PH related risk indicators to form a synthetic informatics signal, the parameter risk definition further defining an extent of contribution from each of the PP and PH related risk indicators to the synthetic informatics signal. The controller is also configured to generate using the one or more processors, a synthetic informatics signal by combining the PP and PH related risk indicators according to the parameter risk definitions, and displaying the synthetic informatics signal on a display.

### BRIEF DESCRIPTION OF THE DRAWINGS

FIG. 1 is a flow chart of at least one method for generating a patient condition index.

FIG. 2 is a schematic diagram of a synthetic informatics visualization system, in accordance with an embodiment.

FIG. 3 is an illustration of a synthetic informatics signal shown on a display, in accordance with an embodiment.

FIG. 4 are illustrations of synthetic informatics signals shown on a display, in accordance with an embodiment.

FIG. 5 are illustrations of synthetic informatics signal shown on a display, in accordance with an embodiment.

### DETAILED DESCRIPTION OF THE INVENTION

The following detailed description of certain embodiments will be better understood when read in conjunction with the appended drawings. To the extent that the figures illustrate diagrams of the functional blocks of various embodiments, the functional blocks are not necessarily indicative of the division between hardware circuitry. For example, one or more of the functional blocks (e.g., controllers, processors, memories) may be implemented in a single piece of hardware (e.g., a general purpose signal processor or a block of random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, the terms “system,” “unit,” “subsystems,” or “module” may include a hardware and/or software system that operates to perform one or more functions. For example, a module, unit, or system may include a computer processor, controller, or other logic-based device that performs operations based on instructions stored on a tangible and non-transitory computer readable storage medium, such as a computer memory. Alternatively, a module, unit, or system may include a hard-wired device that performs operations based on hard-wired logic of the device. Various modules or units shown in the attached figures may represent the hardware that operates based on software or hardwired instructions, the software that directs hardware to perform the operations, or a combination thereof.

“Systems,” “units,” “subsystems,” or “modules” may include or represent hardware and associated instructions (e.g., software stored on a tangible and non-transitory computer readable storage medium, such as a computer hard drive, ROM, RAM, or the like) that perform one or more operations described herein. The hardware may include electronic circuits that include and/or are connected to one or more logic-based devices, such as microprocessors, processors, controllers, or the like. These devices may be off-the-shelf devices that are appropriately programmed or instructed to perform operations described herein from the instructions described above. Additionally or alternatively, one or more of these devices may be hard-wired with logic circuits to perform these operations.

As used herein, an element or step recited in the singular and preceded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Various embodiments provide systems and methods for correlating disparate information from multiple sources to create a derived synthetic informatics based signal. The synthetic informatics signal is a patient condition index based on multiple physiological parameters, patient history, medical procedure risk and other risk factors weighted by an algorithm using risk parameters. The synthetic informatics signal is formed to provide real time updates of potential risk factors for the patient and provide personalized indexing for the patient throughout a medical procedure. The synthetic informatics signals may in turn be used to provide guidance on risk, functional performance, or derivative measure such that threshold of care can be determined and set to aid in the interpretation of the condition of the patient.

The synthetic informatics signal may be visualized as an analog representation of a patient status relative to a risk of the medical procedure. For example, the analog representation may be a tachometer with a defined “red zone” indicating high risk. A technical effect of at least one embodiment includes increased sensitivity and specificity for alarms/alerts. A technical effect of at least one embodiment includes the ability to take multiple complex informational and parametric data sources, and combine these into one analog signal that enables a significant reduction in both display and human memory retention. A technical effect of at least one embodiment includes a higher degree of personalization of care delivered to the patient. A technical effect of at least one embodiment includes customization of viewing the derived signal or any particular situation empowers physician planning and procedural decision support.

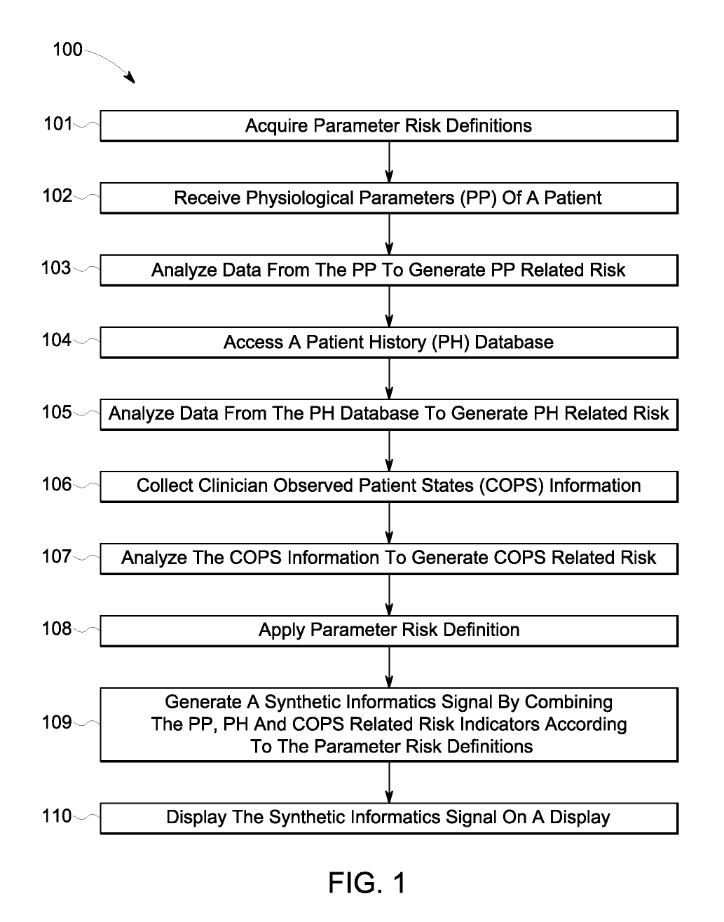

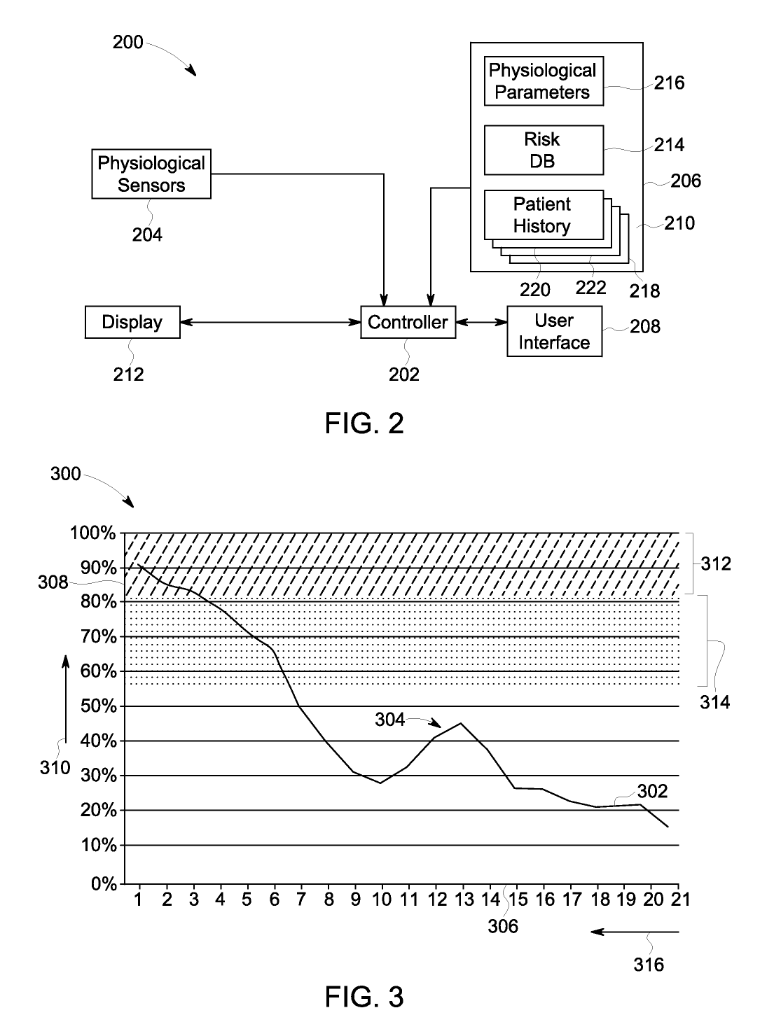

FIG. 1 illustrates a flowchart of a method 100 for generating a patient condition index. The method 100, for example, may employ structures or aspects of various embodiments (e.g., systems and/or methods) discussed herein (e.g., the system 200 in FIG. 2). In various embodiments, certain steps (or operations) may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion. In various embodiments, portions, aspects, and/or variations of the method 100 may be used as one or more algorithms to direct hardware to perform one or more operations described herein. It should be noted, other methods may be used, in accordance with embodiments herein.

One or more methods may (i) receive physiological data of a patient, (ii) analyze data from the physiological parameters to generate a physiological parameter related risk indicator, (iii) accessing a patient history database, (iv) analyze data from the patient history database to generate a patient history related risk indicator, (v) acquire parameter risk definitions, (iv) generate a synthetic informatics signal by combining the physiological parameters, patient history, and clinician observed patient state related risk indicators according to the parameter risk definitions, and (vi) display the synthetic informatics signal on a display.

Beginning at 101, parameter risk definitions are acquired, for example by a controller 202. FIG. 2 is a schematic diagram of a synthetic informatics visualization system 200, in accordance with an embodiment. In the illustrated embodiment, the system 200 includes a controller 202, physiological sensors 204, a user interface 208 (e.g., keyboard, computer mouse, touchscreen interface), a display 212 (e.g., LCD screen, plasma screen, computer display), and memory 206 (e.g., RAM, ROM, harddrive). These components may communicate with each other via wired and/or wireless communication connections. The memory 206 is an electronic storage device configured to store a patient history database 210, a risk database 214, and physiological parameters 216.

The parameter risk definitions may be numeric values indicative of a defined risk when the parameters (e.g., physiological parameters of a patient, data from the patient history database, patient state data) are combined according to a relationship allocating a corresponding weight. The parameter risk definitions represent a quantifiable relationship between each set of parameters with the selected weight or proportion afforded to each parameter used by the controller 202 to determine the synthetic informatics signal. Optionally, the parameter risk definitions may be numerical values, percentages, limits, or the like. The parameter risk definitions are used to customize or tailor the synthetic informatics signal to a specific patient or needs of the clinician. Equation 1 may represent an algorithm used by the controller 202 to calculate the synthetic informatics signal. It should be noted that although equation 1 shows a summing algorithm in other embodiments, the algorithm may use a form of convolution, integration, or the like, to generate the synthetic informatics signal.

(Procedure)d*Σ((PatientHistory)a+(PhyParameters)b+(PatientState)c) (Equation 1)

Equation 1 is based on four generated parameter related risk indicators illustrated as variables PatientHistory (e.g., representing a patient history related risk indicator), PhyParameters (e.g., representing a physiological parameter related risk indicator), PatientState (e.g., representing a patient state related risk indicator), and Procedure (e.g., representing a medical procedure related risk indicator). Each of the related risk indicators are a numeric value indicative of the condition of the patient as indicated by a corresponding parameter. The numeric value may be set along a scale or range between an upper and lower condition limit. It should be noted, in other embodiments the algorithm may be based on greater than or fewer than four related risk indicators.

Each of the parameter related risk indicators are weighted and/or selected by the parameter risk definitions illustrated as variables a, b, c, and d. The parameter related risk indicators may be selected by the clinician using the parameter risk definitions. For example, the clinician may determine that the PatientHistory and PhyParameters are to constitute a greater proportion than the PatientState by the controller 202 to generate the synthetic informatics signal. The user may adjust the parameter risk definition variable c using the user interface 208 to reduce the proportion (e.g., zero) of the PatientState relative to PatientHistory and PhyParameters.

The parameter risk definitions may be received by the controller 202 via the user interface 208. The parameter risk definitions are used to by the controller 202 to define the weight or proportion for each risk attributed by the parameter related risk indicators to the synthetic informatics signal. For example, during the medical procedure the controller 202 may receive parameter risk definitions assigning the Procedure and PatientHistory with a higher proportion of the synthetic informatics signal generated by the controller 202 relative to the Patient State and the PhyParameters. Optionally, once the medical procedure is concluded, the parameter risk definitions may be adjusted by the controller 202 assigning a higher proportion of the synthetic informatics signal to be attributed to the PatientState and the PhyParameters than the PatientHistory component.

Additionally or alternatively, the parameter risk definitions may be predetermined based on procedure profile templates stored on the memory 206. For example, the display 212 may show a list of procedure profile templates stored on the memory 206. The controller 202 receives a selected procedure profile template corresponding to, for example, a spinal osteomyelitis surgery from the user interface 208. The controller 202 adjusts the parameter risk definitions in accordance with the procedure profile template. Optionally, controller 202 may create and/or update procedure profile templates to store on the memory 206 based on inputs received by the user interface 208. Additionally or alternatively, the controller 202 may receive procedure profile templates and/or updates for the procedure profile templates remotely, for example, from a remote medical server.

Optionally, the algorithm used by the controller 202 may include a plurality of risk equations, such as the risk equation shown in equation 1. The plurality of risk equations each may correspond to one of a series of medical procedures performed on the patient, which may be used by the controller 202 to generate the synthetic informatics signal. Each risk equation may be weighted or controlled by the Procedure variable such that only the applicable risk equation corresponding to the medical procedure performed is used by the controller 202 to generate the synthetic informatics signal.

For example, the patient is undergoing a series of medical procedures, of which, one of the medical procedures, is a pacing medical procedure. During the pacing medical procedure the clinician is directly driving the heart affecting the real-time physiological parameters of the patient. The controller 202 updates the Procedure variables of the risk equations to correspond to the pacing medical procedure being performed on the patient. Once updated, risk equations having parameter risk definitions that include a low or zero proportion weight for the PhyParameters will have a greater value Procedure variable than risk equations having parameter risk definitions with a high proportion weight for the PhyParameters. The Procedure variables filter out or reduce the proportion of risk equations corresponding to a condition of the patient based on the real-time physiological parameters, which are used by the controller 202 to generate the synthetic informatics signal.

At 102, the method 100 receives data for one or more physiological parameters 216 of a patient. The data for the physiological parameters 216 are acquired by the physiological sensors 204 in real time during a medical procedure, during a patient recovery period (e.g., after the medical procedure) or the like, and stored on the memory 206. The physiological parameters 216 may include, for example, heart rate measurements, blood pressure measurements, heart electrical measurements (e.g., 12-lead ECG measurements), respiratory rate, or the like, of the patient. For example, during a medical procedure (e.g., cardiac ablation), the physiological sensors 204 (e.g., 12-lead ECG, heart rate, blood pressure) may measure the physiological parameters 216 of the patient in real time or instantaneously during the medical procedure. The controller 202 receives the physiological parameters 216 from the physiological sensors 204, and stores the physiological parameters 216 on the memory 206. Optionally, the physiological parameters 216 may be displayed on the display 212.

Additionally or alternatively, the physiological parameters 216 may include calculated values by the controller 202 representing additional physiological measurements based on measurements from the physiological sensors 204. For example, the controller 202 may determine ST depression, detection of arrhythmia, or the like, based on ECG waveforms acquired by one or more of the physiological sensors 204 (e.g., 12-lead ECG). In another example, the controller 202 may determine a rate or amount of change in physiological parameters 216, such as, a percentage increase in blood pressure or heart rate.

At 103, the method 100 analyzes data from the physiological parameters to generate a physiological parameter related risk indicator. The physiological parameter related risk indicator may be a numeric value calculated by the controller 202 indicative of a condition of the patient as indicated by a corresponding physiological parameter. The controller 202 may generate the physiological parameter related risk indicator based on specific rules stored on the risk database 214, for example, as shown in U.S. Pat. No. 7,542,955, which is hereby expressly incorporated herein by reference in its entirety. The rules are used by the controller 202 to determine an amount of risk, functional performance or derivative measure attributed to each physiological parameter related risk indicator. Each rule may represent a pathological condition resulting in an abnormal or borderline serious or fatal health condition for the patient. The rules may be based on, for example, measurement limits (e.g., physiological data values), thresholds received by the user interface 208, priori information based on statistical risks from medical conditions or medications, or the like Additionally or alternatively, the rules may also comprise Boolean statements that include one or more measurement limit statements, one or more values and/or value ranges or limits.

Optionally, the rules applied (e.g., select applicable Boolean statements) by the controller 202 to the physiological parameters may be selected by the clinician from a drop down menu while using the user interface 208. The user interface 208 is configured to receive input information from a clinician (e.g., a doctor, nurse). The user interface 208 may include one or more user devices, such as a keyboard, a mouse, touchscreen, and/or a graphical user interface overlaid on the display 212. The user interface 208 may transmit the input information to the controller 202 for processing. For example, the clinician may input the standard physiological data 220 (e.g., weight).

At 104, the method 100 accesses the patient history database 210. The patient history database 210 may include standard background physiological data 220, such as age, gender, race, height, and weight stored on the memory 206 accessed by the controller 202. The patient history database 210 may also include medical history data 222, such as medications (e.g., prescription medications, anesthetics) used or applied to the patient, timing information on an effective duration of the medication once used or applied to the patient, pre-existing conditions of the patient (e.g., diabetes, angina, previous heart attacks, congestive heart failure, hypertension), and/or medical procedure history (e.g., pace maker, coronary artery bypass surgery). Optionally, the medical history data 222 may include the type of medical procedure performed on the patient during acquisition of the physiological parameters 216. Additionally or alternatively, the controller 202 may add information to the patient history database 210 based on inputs received from the user interface 208. Optionally, data or information may be added to the patient history database 210 by the controller 202 remotely from a remote medical server.

At 105, the method 100 analyzes data from the patient history database 210 to generate a patient history related risk indicator. The patient history related risk indicator may be a numeric value calculated by the controller 202 indicative of a condition of the patient as indicated by patient history information from the corresponding patient history database 210. The controller 202 may generate the patient history related risk indicator based on specific rules stored on the risk database 214. The rules are used by the controller 202 to determine an amount of risk, functional performance or derivative measure attributed to the patient history related risk indicator. Each rule may represent a pathological condition resulting in an abnormal or borderline serious or fatal health condition for the patient based on data from the patient history database 210. The rules may be based on, for example, measurement limits (e.g., number of previous medical procedures), priori information based on statistical risks from medical conditions or medications, or the like Additionally or alternatively, the rules may also comprise Boolean statements that include one or more measurement limit statements, one or more values and/or value ranges or limits. Optionally, the rules applied (e.g., select applicable Boolean statements) to data of the patient history database 210 by the controller 202 may be selected by the clinician from a drop down menu by using the user interface 208.

At 106, the method 100 collects clinician observed patient state information. The clinician observed patient state information may be stored within clinician observed patient state (COPS) data 218 of the memory 206. The COPS information may be medical observations corresponding to the patient state, such as, the patient is conscious, the patient is verbally communicating, presence of cyanosis, or the like, by the clinician received by the controller 202 via the user interface 108. Optionally, the COPS information may be based on predetermined Boolean statements shown on the display 212 (e.g., using drop down menus), to which the clinician selects a response regarding a status of the patient. The Boolean statements may be based on the medical history data 222, the medical procedure performed, or the like. For example, the display 212 may show Boolean statements requesting the clinician to indicate whether the patient feels pain in specified locations that were operated on during the medical procedure.

At 107, the method 100 analyzes the COPS data 218 to generate a COPS related risk indicator. The COPS related risk indicator may be a numeric value calculated by the controller 202 indicative of a condition of the patient as indicated by the corresponding COPS data 218. The controller 202 may generate the COPS related risk indicator based on specific rules stored on the risk database 214. The rules are used by the controller 202 to determine an amount of risk, functional performance or derivative measure attributed to the COPS related risk indicator. Each rule may represent a pathological condition resulting in an abnormal or borderline serious or fatal health condition for the patient based on data from the patient history database 210. The rules may be based on, for example, measurement limits (e.g., number of previous medical procedures), priori information based on statistical risks from medical conditions or medications, or the like Additionally or alternatively, the rules may also comprise Boolean statements that include one or more measurement limit statements, one or more values and/or value ranges or limits. Optionally, the rules applied (e.g., select applicable Boolean statements) to data of the COPS data 218 by the controller 202 may be selected by the clinician from a drop down menu by using the user interface 208.

Optionally, the method 100 may include analyzing the medical procedure being performed on the patient to determine a medical procedure related risk indicator. The medical procedure related risk indicator may be a numeric value calculated by the controller 202 indicative of a condition of the patient as indicated by the corresponding medical procedure being performed. It should be noted that more than one medical procedure related risk indicator may be analyzed. The number of medical procedure related risk indicators may be based on the number of medical procedures being performed by the clinician and/or the number of medical procedures selected by the clinician using the user interface 208 to be analyzed by the controller 202.

At 108, apply the parameter risk definition. For example, the controller 202 may quantify the relationship or proportions between the related risk indicators (e.g., the physiological parameters related risk indicator, patient history related risk indicator, observation related risk indicator) to each of the related risk indicators.

At 109, the method 100 generates the synthetic informatics signal by combining the PP, PH, and COPS related risk indicators according to the parameter risk definitions. The controller 202 controls the operation of the system 200, and is configured to generate a patient condition index such as the synthetic informatics signal using the algorithm based on the parameter risk definitions at 108 and the related risk indicators determined from the physiological parameters 216, the patient history database 210 and the COPS data 218. The controller 202 may be embodied in hardware, such as a processor, controller, or other logic-based device, that performs functions or operations based on one or more sets of instructions (e.g., software). The instructions on which the hardware operates may be stored on a tangible and non-transitory (e.g., not a transient signal) computer readable storage medium, such as the memory 206. The memory 206 may include one or more computer hard drives, flash drives, RAM, ROM, EEPROM, or the like. Alternatively, one or more of the sets of instructions that direct operations of the hardware may be hard-wired into the logic of the hardware.

At 110, the synthetic informatics signal 302 is displayed on the display 212. The display 212 is configured to display the patient condition index (e.g., the synthetic informatics signal). Additionally or alternatively, the display 212 may be configured to display one or more physiological parameters 216 acquired by the physiological sensors 204. The display 212 may be an LCD (liquid crystal display), plasma display, CRT monitor, or the like. Optionally, the display 212 may include a touch sensitive surface (e.g., sensor or set of sensors that accepts input from a user based on haptic and/or tactile contact), which may be used as a part of the user interface 208. For example, the display 212 may display a graphical user interface, which is interfaced by the clinician by interacting (e.g., touching) with the touch sensitive surface.

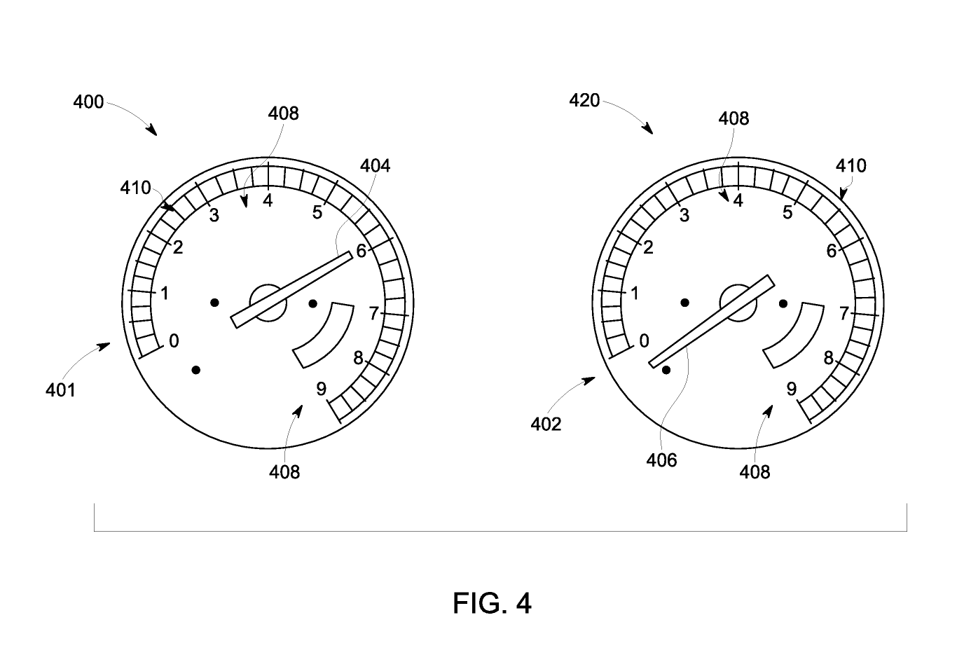

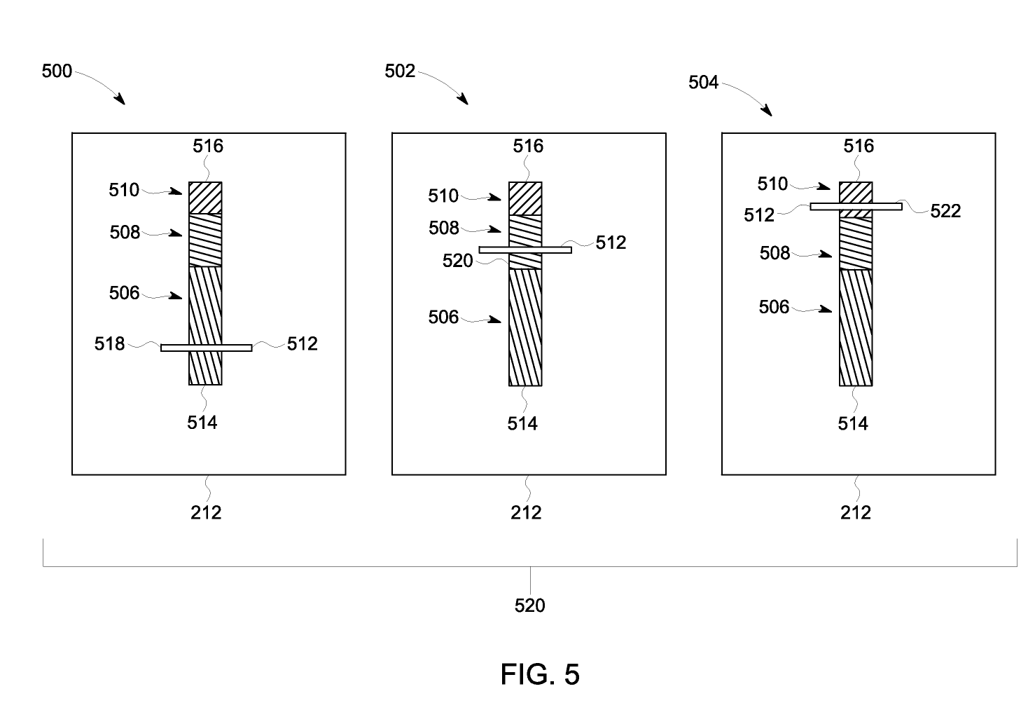

FIG. 3 is an illustration 300 of the synthetic informatics signal 302 shown on the display 212. The synthetic informatics signal 302 is shown as a line graph plotted over a horizontal axis 306 representing time. A vertical axis 308 may represent a level of risk of the patient. For example, the risk to the health or mortality of the patient increases and/or a condition of the patient decreases while traversing in a direction of an arrow 310 along the vertical axis 308. It should be noted in other embodiments the vertical axis 308 may represent an overall patient condition. Additionally or alternatively, the synthetic informatics signal 302 may be illustrated differently, for example, as a tachometer (as shown in FIG. 4), a numeral value, a bar graph (as shown in FIG. 5), combinations thereof, or the like.

The illustration 300 may scroll or update the synthetic informatics signal 302 in real time and/or dynamically as the synthetic informatics signal 302 is calculated by the controller 202. The scrolling of the illustration 300 on the display 212 allows the clinician to continuously view the synthetic informatics signal 302 in real time, as well as view a historical trend of the synthetic informatics signal 302 overtime. Optionally, the illustration 300 may show a predetermined time range of the synthetic informatics signal 302 as the illustration 300 is scrolled or updated with the real time or instantaneous synthetic informatics signal 302. For example, the horizontal axis 306 representing time maybe scrolled or shifted in the direction of an arrow 316, while additional calculations of the synthetic informatics signal 302 is added to the line graph.

Additionally or alternatively, regions of action 312, 314 may be overlaid on the display 212 to highlight alert states. The regions of action 312, 314 may represent when the risk or condition of the patient during the medical procedure is above a set threshold. Each region of action 312, 314 may correspond to predetermined and/or selected alert responses defined by the clinician using the user interface 208. For example, when the synthetic informatics signal 302 enters the region of action 314 the controller 202 may transmit an alert, such as, a graphical flash and/or alert banner on the display 212. In another example, when the synthetic informatics signal 302 enters the region of action 316 the controller 202 may transmit an alert sound or other audible alert. Optionally, the controller 202 may transmit an alert message to a remote system (e.g., a remote server, a remote messaging system, a mobile phone). The regions of action 312, 314 may be defined by thresholds corresponding to inputs of the user interface 208 received by the controller 202. Additionally or alternatively, the regions of action 312, 314 may be predetermined based on thresholds and/or ranges stored on the memory 206.

Optionally, the display 212 may show multiple synthetic informatics signals 400 and 420 of the patient. FIG. 4 illustrates two instantaneous synthetic informatics signals 400 and 420 shown on the display 212 represented as two gauges 401 and 402 similar to a tachometer. Each gauge 401 and 402 includes a needle 404 and 406, respectively. The distal end of each needle 404 and 406 points to a corresponding numeral along a scale 408 representing the instantaneous synthetic informatics signal 400 shown on the gauges 401 and 402, respectively. The scale 408 may also include a color spectrum 410 based on a regions of action corresponding to positions and/or regions on the scale 408. It should be noted, that in other embodiments the display 212 may show more than two synthetic informatics signals

Optionally, each of the gauges 401 and 402 may represent the condition or risk of the patient customized for multiple clinicians during a single medical procedure. For example, the controller 202 may receive from each clinician, using the user interface 208, the parameter risk definitions and related risk indicators used for determining the synthetic informatics signal 400, 420 for the respective clinician. Based on the received inputs, the controller 202 tailors or customize the gauges 401 and 402 to correspond to the risk or condition of the patient attributed to the responsibilities of each clinician. For example, a first clinician may adjust the parameter risk definitions via the user interface 208 to designate a risk profile for the patient while under anesthesia. Another clinician may adjust the parameter risk definitions by the user interface 208 designating a risk profile for the patient associated with surgery. Each risk profile will be generated by the controller 202 to provide individual synthetic informatics signals 400, 420 for each clinician shown on the gauges 401 and 402, respectively.

In at least one embodiment, each of the synthetic informatics signals 400, 420 may correspond to different portions or subsets of a medical procedure performed on the patient. For example, the controller 202 may adjust the parameter definitions to provide multiple risk profiles for the patient during a cardiac ablation medical procedure. A first risk profile, shown on the gauge 401, may correspond to the patient condition or risk of the patient during implantation of a catheter, and a second risk profile, shown on the gauge 402, may correspond to the patient condition or risk of the patient during application of electrical energy to scar or destroy specific heart tissue.

FIG. 5 illustrates instantaneous synthetic informatics signals 520 shown on the display 212 as a bar graph. The instantaneous synthetic informatics signals 520 are illustrated at three different time periods or states 500, 502, 504 during a medical procedure. The instantaneous synthetic informatics signal 520 is shown on each bar graph using a marker 512. A position of the marker 512 on the bar graph corresponds to a value of risk or patient condition. For example, the marker 512 positioned proximate to a low position of the bar graph at 514 corresponds to a minimal or low risk of the patient. The marker 512 positioned proximate to an upper portion of the bar graph at 516 corresponds to a high risk of the patient.

Each bar graph is subdivided into three regions of action 506, 508, and 510. Each region of action 506, 508, and 510 may correspond to a predetermined or defined response for the controller 202 stored on the memory 206. For example, when the instantaneous synthetic informatics signal 520 enters the region of action 508 the controller 202 transmits an audible alert. The defined response may be based on ranges or thresholds received from the user interface 208. Optionally, the defined responses may be defined concurrently with the parameter risk definitions based on inputs from the user interface 108.

During the medical procedure, the marker 512 may change positions on the bar graph based on the instantaneous synthetic informatics signal 520 determined by the controller 202 at the different time periods 500, 502, 504. For example, the time period 500 occurs before the clinician begins the medical procedure. The controller 202 receives the real time physiological parameters 216 of the patient (e.g., at 102 of the method 100) and accesses the patient history database 210 (e.g., at 104 of the method 100). The patient history database 210 may include a pre-existing condition of the patient, such as, diabetes. Further, the patient history database 210 may include observational data, such as, administering medication to the patient. The controller 202 receives the parameter risk definitions from the user interface 208, and generates the instantaneous synthetic informatics signal 520 for the time period 500. Based on the instantaneous synthetic informatics signal 520, the controller 202 positions the marker 512 at a position 518.

During the time period at 502, medication may be administered to the patient. Once the medication is administered, the patient history database 210 may be updated by the controller 202. Concurrently, the physiological sensors 204 may measure an increase in blood pressure and heart rate, which may be stored on the physiological parameters 216 by the controller 202. Based on the updated patient history database 210 and the physiological parameters 216 the controller 202 determines an instantaneous synthetic informatics signal 520 for the time period 502. From the instantaneous synthetic informatics signal 520, the controller 202 positions the marker 512 at a position 519.

During the time period at 504, the physiological sensors 204 may measure an additional increase in heart rate and blood pressure, which may be stored on the physiological parameters 216 by the controller 202. Concurrently, the controller 202 may receive observational information, corresponding to a change in color of the patient, from the user interface 208, which may be stored by the controller 202 to the COPS data 218. Based on the updated physiological parameters 216 and the updated observational data on the patient history database 210, the controller 202 may determine an instantaneous synthetic informatics signal 520 for the time period 504. From the instantaneous synthetic informatics signal 520, the controller 202 positions the marker 512 at a position 522.

In one example of the inventive subject matter, a method includes receiving, using one or more processors, physiological parameters (PP) of a patient, and analyzing data from the PP to generate a PP related risk indicator. The method includes accessing a patient history (PH) database, and analyzing data from the PH database to generate PH related risk indicator. The method includes acquiring parameter risk definitions. The parameter risk definition defines a set of rules for combining the PP and PH related risk indicators to form a synthetic informatics signal. The method includes generating, using the one or more processors, a synthetic informatics signal by combining the PP and PH related risk indicators according to the parameter risk definitions, and displaying the synthetic informatics signal on a display.

In one aspect, the parameter risk definition further defining an extent of contribution from each of the PP and PH related risk indicators to the synthetic informatics signal.

In one aspect, the method may include overlaying the region of action on the display that corresponds to an alert response. Optionally, the alert response of the method may include a graphical flash on the display, alert banner on the display, or an audible alert.

In one aspect the method may include acquiring, using the one or more processors, a second set of parameter risk definitions, generating, using the one or more processors, a second synthetic informatics combining the PP related risk indicator and the PH related risk indicator according to the second set of parameter risk definitions; and displaying the second synthetic informatics signal on the display.

In one aspect, the method may include collecting clinician observations corresponding to a clinician observed patient state (COPS), and analyzing the COPS data to generate COPS related risk indicator. The parameter risk definitions further corresponds to a proportion allocated to the COPS related risk indicator of the synthetic informatics signal, and the synthetic informatics signal generated includes the COPS related risk indicator according to the parameter risk definition.

In one aspect, the parameter risk definitions of the method are required from a procedure profile template based on input from a user interface.

In one aspect, the wherein the PP related risk indicator and the PH related risk indicator are generated based on at least one of a pathological condition, measuring limits, or priori information stored on a parameter risk database.

In one aspect, the synthetic informatics signal of the method is displayed as a line graph, a bar graph, or tachometer. Optionally, the line graph may include a predetermined time range of the synthetic informatics signal.

In one example of the inventive subject matter, a system includes one or more physiological sensors configured to acquire physiological parameters from a patient, a memory device configured to store a patient history (PH) database; and a display configured to display a synthetic informatics signal; and a controller. The controller configured to receive physiological parameters (PP) from the physiological sensors, analyze data from the PP to generate a PP related risk indicator, analyze data from the PH database to generate PH related risk indicator, and acquire parameter risk definitions. The parameter risk definition defines a set of rules for combining the PP and PH related risk indicators to form a synthetic informatics signal, the parameter risk definition further defining an extent of contribution from each of the PP and PH related risk indicators to the synthetic informatics signal. The controller is also configured to generate using the one or more processors, a synthetic informatics signal by combining the PP and PH related risk indicators according to the parameter risk definitions.

It should be noted that the particular arrangement of components (e.g., the number, types, placement, or the like) of the illustrated embodiments may be modified in various alternate embodiments. For example, in various embodiments, different numbers of a given module or unit may be employed, a different type or types of a given module or unit may be employed, a number of modules or units (or aspects thereof) may be combined, a given module or unit may be divided into plural modules (or sub-modules) or units (or sub-units), one or more aspects of one or more modules may be shared between modules, a given module or unit may be added, or a given module or unit may be omitted.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein. Instead, the use of “configured to” as used herein denotes structural adaptations or characteristics, and denotes structural requirements of any structure, limitation, or element that is described as being “configured to” perform the task or operation

It should be noted that the various embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a solid-state drive, optical disk drive, and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), ASICs, logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments. The set of instructions may be in the form of a software program. The software may be in various forms such as system software or application software and which may be embodied as a tangible and non-transitory computer readable medium. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f) unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal language of the claims.

What is claimed is:

1. A method for generating a patient condition index, the method comprising:
receiving physiologic parameter (PP) data indicative at least one physiological parameter of interest of a patient;
analyzing the PP data to generate a PP related risk indicator;
accessing a patient history (PH) database to acquire PH information;
analyzing the PH information from the PH database to generate PH related risk indicator;
acquiring a parameter risk definition, wherein the parameter risk definition defines a set of rules for utilizing the PP and PH related risk indicators to form a synthetic informatics signal;
generating a synthetic informatics signal by combining the PP and PH related risk indicators according to the parameter risk definitions; and
displaying the synthetic informatics signal on a display.

2. The method of claim 1, further comprising overlaying a region of action on the display, wherein the region of action corresponds to an alert response.

3. The method of claim 2, wherein the alert response includes a graphical flash on the display, an alert banner on the display, or an audible alert.

4. The method of claim 1, further comprising acquiring, using the one or more processors, a second set of parameter risk definitions;
generating, using the one or more processors, a second synthetic informatics combining the PP related risk indicator and the PH related risk indicator according to the second set of parameter risk definitions; and
displaying the second synthetic informatics signal on the display.

5. The method of claim 4, wherein the second synthetic informatics signal is displayed concurrently with the synthetic informatics signal.

6. The method of claim 1, wherein the PP related risk indicator and the PH related risk indicator are generated based on at least one of a pathological condition, measuring limits, or priori information stored on a parameter risk database.

7. The method of claim 1, wherein the parameter risk definitions are acquired from a procedure profile template based on an input from a user interface.

8. The method of claim 1, further comprising collecting clinician observed patient state (COPS) information indicative of a patient state observed by the clinician;
analyzing the COPS information to generate a COPS related risk indicator, wherein the parameter risk definitions further includes a proportion allocated to the COPS related risk indicator such that the synthetic informatics signal is generated in part based on the COPS related risk indicator.

9. The method of claim 1, wherein the synthetic informatics signal is displayed as a line graph, a bar graph, or a tachometer.

10. The method of claim 1, wherein the parameter risk definition further defining an extent of contribution from each of the PP and PH related risk indicators to the synthetic informatics signal.

11. A system for generating a patient condition index, comprising:
one or more physiological sensors configured to acquire physiological parameters from a patient;
a memory device configured to store a patient history (PH) database;
a display configured to display a synthetic informatics signal;
a controller configured to:
receive physiological parameters (PP) from the physiological sensors;
analyze data from the PP to generate a PP related risk indicator;
analyze data from the PH database to generate PH related risk indicator
acquire parameter risk definitions, wherein the parameter risk definitions correspond to a proportion allocated to each of the PP and PH related risk indicators of the synthetic informatics signal; and
generate a synthetic informatics signal by utilizing the PP and PH related risk indicators according to the parameter risk definitions.

12. The system of claim 11, wherein the controller is configured to overlay a region of action on the display, wherein the region of action corresponds to an alert response.

13. The system of claim 12, wherein the alert response includes a graphical flash on the display, an alert banner on the display, or an audible alert.

14. The system of claim 11, wherein the controller is configured to acquire a second set of parameter risk definitions, and generate, a second synthetic informatics combining the PP related risk indicator and the PH related risk indicator according to the second set of parameter risk definitions, the display is configured to display the second synthetic informatics signal.

15. The system of claim 14, wherein the second synthetic informatics signal is displayed concurrently with the synthetic informatics signal.

16. The system of claim 11, wherein the PP related risk indicator and the PH related risk indicator are generated based on at least one of a pathological condition, measuring limits, or priori information stored on a parameter risk database.

17. The system of claim 11, further comprising a user interface configured to receive inputs corresponding to the parameter risk definitions.

18. The system of claim 11, wherein the memory is configured to include clinician observed patient state (COPS) data, the controller configured to analyze the COPS information to generate a COPS related risk indicator, wherein the parameter risk definitions further includes a proportion allocated to the COPS related risk indicator such that the synthetic informatics signal is generated in part based on the COPS related risk indicator.

19. The system of claim 11, wherein the synthetic informatics signal is displayed as a line graph, a bar graph, or a tachometer.

20. The system of claim 19, wherein the line graph includes a predetermined time range of the synthetic informatics signal.
